(19) United States
(12) Patent Application Publication
(10) Pub. No.: US 2013/0067697 A1
(43) Pub. Date: Mar. 21, 2013

(54) ELASTIC SAFETY PULL ROPE

(71) Applicant: Ying-Xuan HUANG, Changhua City (TW)

(72) Inventor: Ying-Xuan HUANG, Changhua City (TW)

(21) Appl. No.: 13/238,311

(22) Filed: Sep. 21, 2011

(51) Int. Cl. F16P 1/00

(52) U.S. Cl. 24/301

(57) ABSTRACT

An elastic safety pull rope with maximum tensile range limitation functions has a telescopic flexible tube, which is a woven fabric tubing provided with an enclosed through-space. At least two elastic threads are assembled into the through-space of the tube. A plurality of weaving fixed portions are fixed onto the joints of the elastic threads and flanged portions of the tube. Two flat joints are formed at two ends of the tube and elastic threads. No extension is possible when the tube is pulled in a straight state, so this could limit the maximum tensile range of the elastic thread. When the two flat joints are pulled to couple with the elastic thread and tube, the flanged portions of the tube could be placed in uniform corrugated state since the weaving fixed portions are linked at interval, thereby preventing possible winding and rupture of the threads with better applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable. cl REFERENCE TO AN APPENDIX SUBMITTED ON COMPACT DISC

Not applicable.

### BACKGROUND OF THE INVENTION

1. Field of the Invention

The present invention relates generally to an elastic pull rope, and more particularly to an innovative one which is provided with maximum tensile range limitation functions.

2. Description of Related Art Including Information Disclosed Under 37 CFR 1.97 and 37 CFR 1.98

Elastic pull ropes are broadly used to connect articles, fitness equipments and safety cables due to elasticity. For instance, the operators on work sites have to manually hold heavy-duty tools (e.g.: nailing guns, chisels and drillers) for their work. When they operate these tools on the ground, no serious personal injury will be caused even if the tools fall down due to personal negligence. However, when the operators work on the scaffolds or at the edge of high-rise buildings, the falling tools will likely hurt other persons or objects due to the acceleration of gravity, leading to unforeseen danger and damage.

Patent Gazette No. M399877 of ROC describes an anti-falling safety rope for tools. This structure is mainly characterized in that it includes an elongated elastic connecting strip and two snap ring units that are fixed at two opposite ends of the strip. The connecting strip consists of a strip unit and several main elastic strips set on the strip unit. The main elastic strips are extended lengthwise, and also arranged at interval in parallel. Every snap ring unit contains a snap ring located at the end and is opened or closed easily. As main elastic strips are set on the strip unit, the connecting strip could be reinforced structurally to prevent rupture and malfunction of main elastic strips due to uneven stress, thus enabling stronger robustness of the anti-falling safety rope for tools.

The main elastic strips are partially exposed to the strip unit, some portions of the main elastic strips are vulnerable to external forces and destructive rupture, so there is still a room for improving the design of the protective structure of the main elastic strips specific to the conventional safety rope.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The present invention provides an elastic safety pull rope with maximum tensile range limitation functions. The elastic safety pull rope includes a telescopic flexible tube, which is a woven fabric tubing provided with an enclosed through-space. At least two elastic threads are assembled linearly in parallel into the through-space of the telescopic flexible tube. A plurality of weaving fixed portions are fixed securely onto the joints of the elastic threads and flanged portions of the telescopic flexible tube. Two flat joints are formed separately at two ends of the telescopic flexible tube and elastic threads. With the present invention, no extension is possible when the telescopic flexible tube is pulled in a straight state, so this could limit the maximum tensile range of elastic thread. When these two flat joints are pulled to couple with the elastic thread and telescopic flexible tube, the flanged portions of the telescopic flexible tube could be placed in uniform corrugated state since the weaving fixed portions are linked at interval, thereby preventing possible winding and rupture of the threads with better applicability.

### BRIEF DESCRIPTION OF THE SEVERAL VIEWS OF THE DRAWINGS

FIG. 1 is an upper perspective view of the elastic pull rope of the present invention.

FIG. 2 is an isolated perspective view of the elastic pull rope of the present invention.

FIG. 3 is a schematic view (1) of the elastic pull rope of the present invention wherein the elastic pull rope isn't pulled.

FIG. 4 is a schematic view (2) of the elastic pull rope of the present invention wherein the elastic pull rope is already pulled.

FIG. 5 is another schematic view of the elastic pull rope of the present invention.

FIG. 6 is a schematic view showing operation of the elastic pull rope of the present invention.

FIG. 7 is another schematic view showing operation of the elastic pull rope of the present invention.

### DETAILED DESCRIPTION OF THE INVENTION

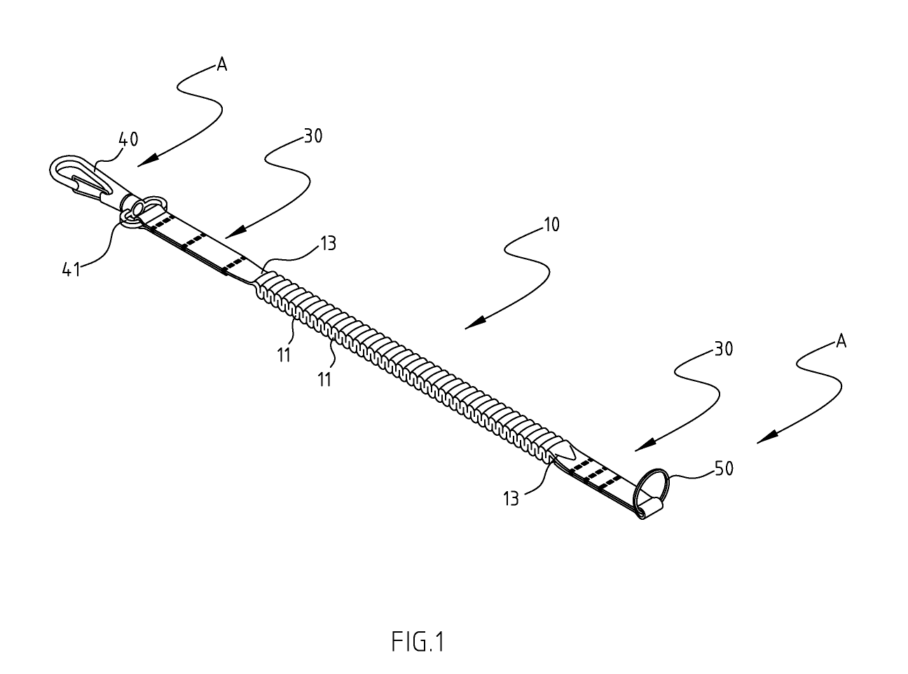

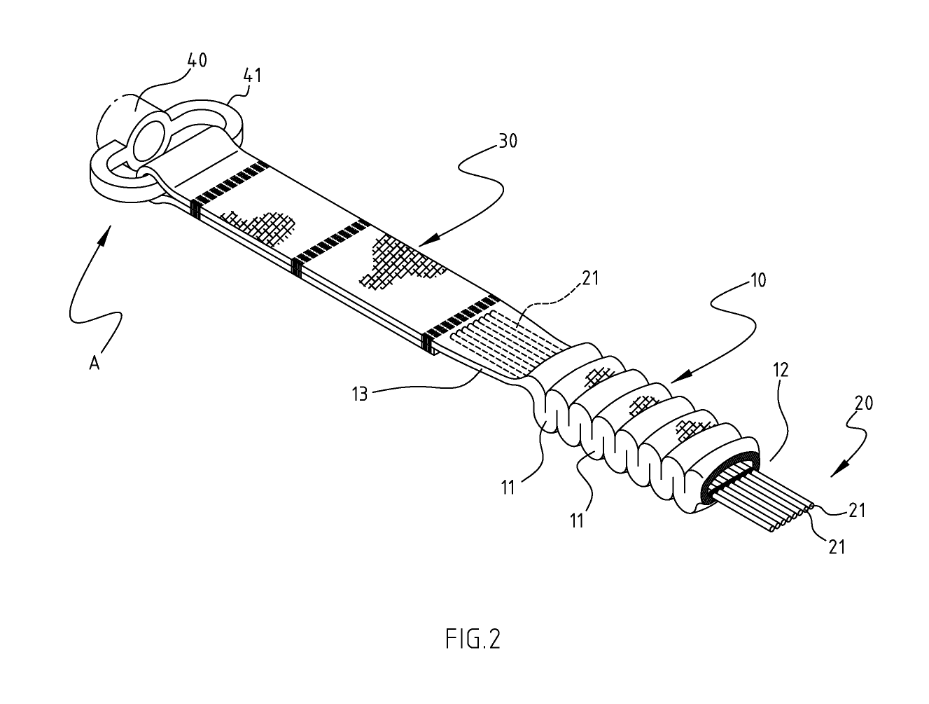

FIGS. 1-6 depict preferred embodiments of an elastic safety pull rope of the present invention with maximum tensile range limitation functions, which, however, are provided for only explanatory objective for patent claims.

The elastic pull rope comprises a telescopic flexible tube 10, which is a woven fabric tubing provided with an enclosed through-space 12. Multiple corrugated flanged portions 11 are uniformly arranged at both sides of the telescopic flexible tube 10.

At least two elastic threads 20 are assembled linearly in parallel into the through-space of the telescopic flexible tube 10, such that the elastic threads 20 are protected by the telescopic flexible tube 10 to avoid destructive rupture. Of which, a joint 22 is defined on the elastic thread 20 correspondingly to the flanged portion 11 of the telescopic flexible tube 10.

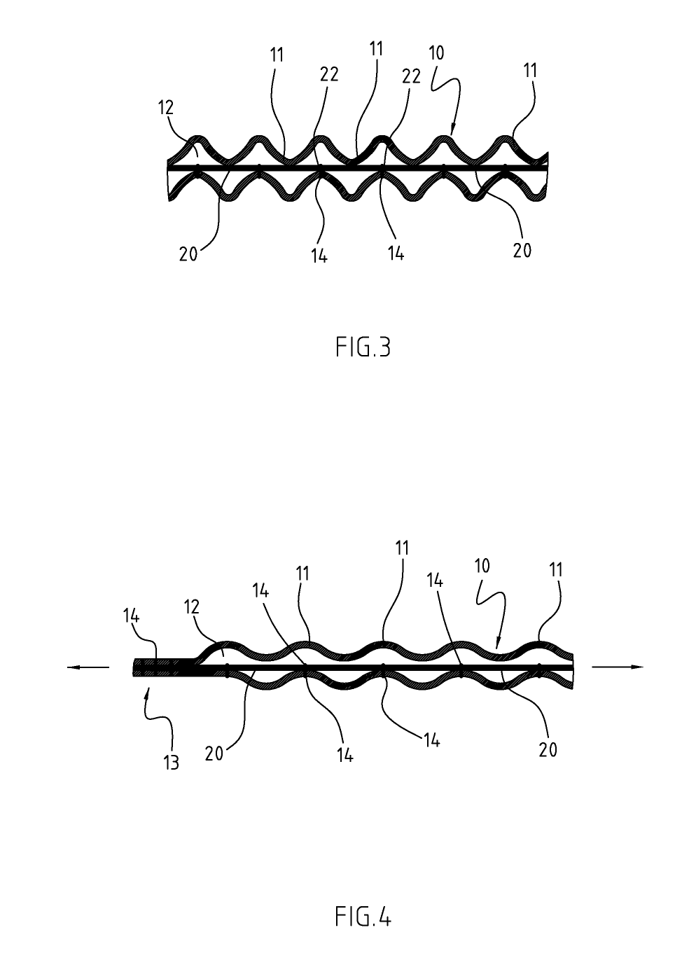

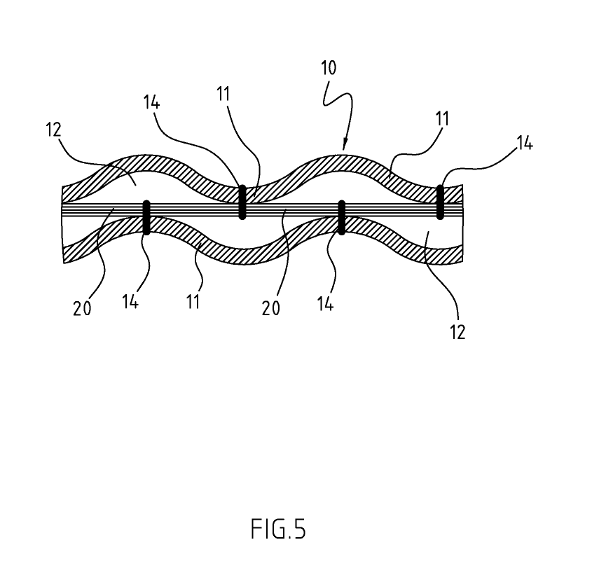

A plurality of weaving fixed portions 14 are fixed securely onto the joints 22 of the elastic threads 20 and flanged portions 11 on at least one flange of the telescopic flexible tube 10. Of which, the joints 22 can be mated correspondingly with the flanged portions 11 on either flange of the telescopic flexible tube 10 (as shown in FIGS. 3, 4), or mated with he flanged portions 11 on both flanges of the telescopic flexible tube 10 (shown in FIG. 5). Then, the elastic thread 20 and telescopic flexible tube 10 are kept in a uniform corrugated state to avoid corrugated displacement or deformation due to excessive use. In the case where one section of the elastic thread 20 is broken, both ends of the broken elastic thread 20 could still generate tensile force since the sections of the weaving fixed portion 14 are reinforced. Of which, the weaving fixed portion 14 in this preferred embodiment is fixed by means of sewing.

Two flat joints 13 are formed separately at two ends of the telescopic flexible tube 10 and elastic threads 20. Said flat joint 13 allows two flanges of the telescopic flexible tube 10 to snap forcibly the elastic threads 20 in woven flat pattern. When these two flat joints 13 are pulled to couple with the elastic thread 20 and telescopic flexible tube 10, the flanged portions 11 of the telescopic flexible tube 10 could be placed in uniform corrugated state since the weaving fixed portions 14 are linked at interval. Additionally, no extension is possible when the telescopic flexible tube 10 is pulled in a straight state, so this could limit the maximum tensile range of the elastic thread 20 to avoid rupture arising from excessive tension. A plurality of weaving fixed portions A is fixed at both flanges of the telescopic flexible tube 10 correspondingly to the elastic threads 20.

Of which, two extension strips 30 are extended separately from the ends of two flat joints 13. A connection A is set at the ends of two extension strips 30. Said connection A is either of a buckle, snapper, snap ring, fixed seat and handle.

Additionally, said telescopic flexible tube 10 is arranged in single section or otherwise in multiple sections at interval. When it is arranged in multiple sections at interval, various sections of telescopic flexible tube 10 can be linked by inflexible strips.

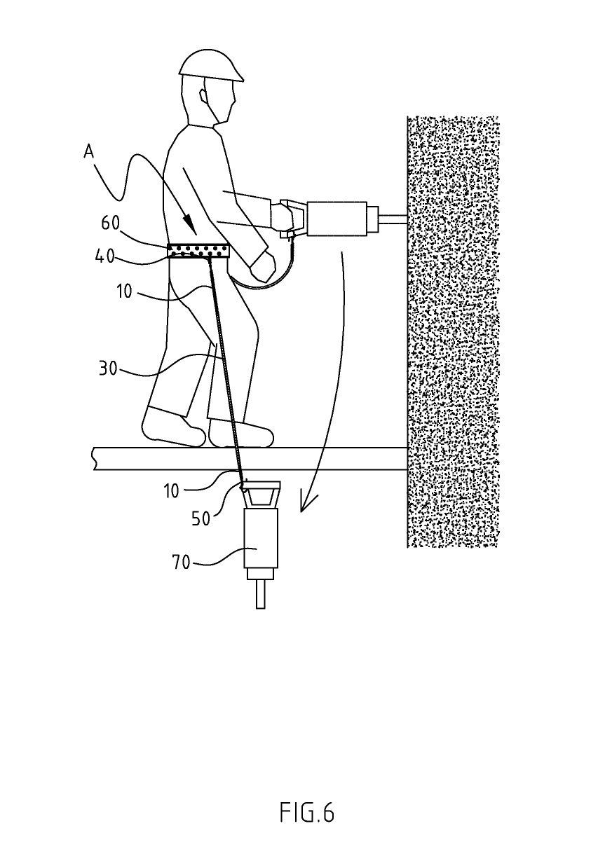

Referring to FIG. 6, when a user intends to use the elastic pull rope, the tooling connection 50 is assembled on a predefined machine tool 70, and the user's connection 40 is linked to the waist belt 60, such that the user could operate overhead or in limited area by elevating the predefined machine tool 70 via elastic pull rope. While buffering the falling force of the predefined machine tool 70, this could relieve any intense physical tension and discomfort, but also maintain uniform corrugated state to avoid corrugated displacement or deformation due to excessive use. Hence, the elastic pull rope of excellent elasticity could prevent winding of the threads.

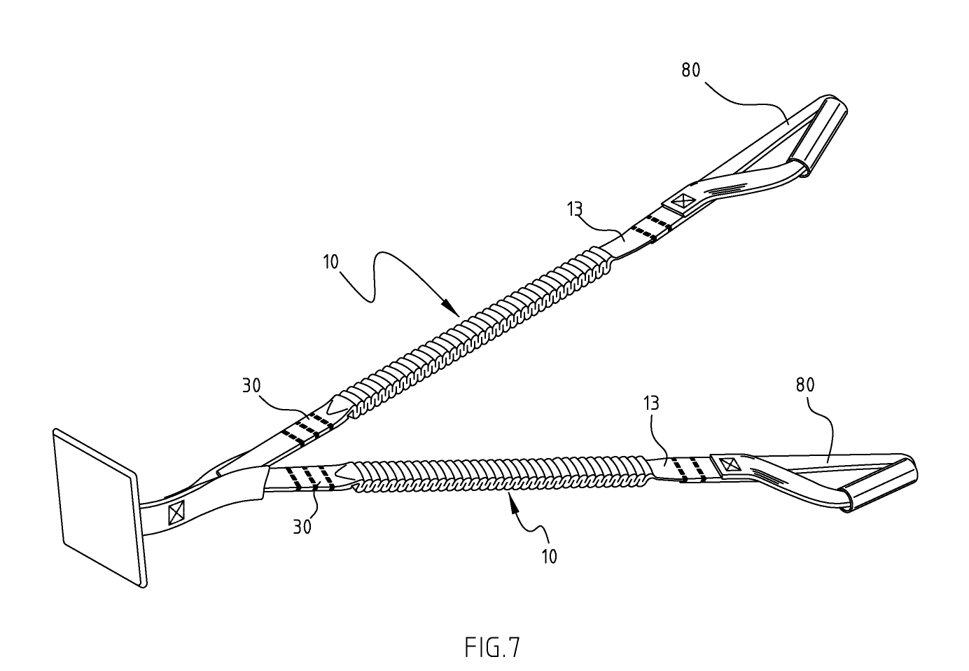

Referring to FIG. 7, a fitness handle 80 is set at both ends of the connection, and a plurality of elastic pull ropes can be used in series. With these characteristics, the elastic pull rope of the present invention could be used as a muscle training device, or as a safety rope of a surfboard in surfing activities. In such a case, both ends of the elastic pull rope are separately linked to the surfboard and ankle of the surfer to ensure personal safety and prevent drifting of the surfboard.

The flanged portion 11 of the telescopic flexible tube 10 of the present invention is mated with the joint 22 of the elastic thread 20 via weaving fixed portion 14, so the elastic thread 20 and telescopic flexible tube 10 can be kept in a uniform corrugated state to avoid corrugated displacement or deformation due to excessive use. In the case where one section of the elastic thread is broken, both ends of the broken elastic thread could still generate tensile force since the sections of the weaving fixed portion are reinforced.

To this end, the inventor has provided the present invention of practicability based on his years of experience in the production, development and design of related products. The present invention is an innovative product not yet publicly available complying with the spirit of new patents, so the patent claims are made hereto.

I claim:

1. An elastic safety pull rope with maximum tensile range limitation functions, which comprising:
a telescopic flexible tube, which is a woven fabric tubing provided with an enclosed through-space; multiple corrugated flanged portions are uniformly arranged at both sides of the telescopic flexible tube;
at least two elastic threads, assembled linearly in parallel into the through-space of the telescopic flexible tube; and a joint is defined on the elastic thread correspondingly to the flanged portion of the telescopic flexible tube;
a plurality of weaving fixed portions, fixed securely onto the joints of the elastic threads and flanged portions on at least one flange of the telescopic flexible tube;
two flat joints, formed separately at two ends of the telescopic flexible tube and elastic threads; said flat joint allows two flanges of the telescopic flexible tube to snap forcibly the elastic threads in woven flat pattern;
when these two flat joints are pulled to couple with the elastic thread and telescopic flexible tube, the flanged portions of the telescopic flexible tube could be placed in uniform corrugated state since the weaving fixed portions are linked at interval; and, no extension is possible when the telescopic flexible tube is pulled in a straight state, so this could limit the maximum tensile range of elastic thread.

2. The structure defined in claim 1, wherein two extension strips are extended separately from the ends of two flat joints; a connection is set at the ends of two extension strips; said connection is either of a buckle, snapper, snap ring, fixed seat and handle.

3. The structure defined in claim 1, wherein said telescopic flexible tube is arranged in single section or otherwise in multiple sections at interval; when it is arranged in multiple sections at interval, various sections of telescopic flexible tube can be linked by inflexible strips.
